(19) United States
(12) Patent Application Publication
(10) Pub. No.: US 2023/0271160 A1
(43) Pub. Date: Aug. 31, 2023

(54) Hydrated porous material and method for preparing same

(71) Applicant: COMMISSARIAT À L'ÉNERGIE ATOMIQUE ET AUX ÉNERGIES ALTERNATIVES, Paris (FR)

(72) Inventors: Matthieu Hamel, Gif-sur-Yvette Cedex (FR); Guillaume Bertrand, Gif-sur-Yvette Cedex (FR); Benoit Sabot, Gif-sur-Yvette Cedex (FR); Vincent Villemot, Gif-sur-Yvette Cedex (FR)

(21) Appl. No.: 18/006,808

(22) PCT Filed: Jul. 29, 2021
(86) PCT No.: PCT/FR2021/051421

§ 371 Date: Jan. 25, 2023

(30) Foreign Application Priority Data
Jul. 30, 2020 (FR) 2008120

(51) Int. Cl. B01J 20/30; B01J 20/22; B01J 20/28; G01T 1/202

(52) U.S. Cl. CPC B01J 20/3085; B01J 20/226; B01J 20/28064; B01J 20/28066; G01T 1/2026

(57) ABSTRACT

A method of checking the storage and the radioactive activity of a radioactive gas adsorbed by a porous material having scintillation properties, which comprises: (a) putting the porous material in place in an enclosure, (b) performing circulation of the radioactive gas in the enclosure, (c) monitoring the adsorption of the radioactive gas by monitoring the scintillation of the porous material, up to an adsorption level, (d) interrupting the radioactive gas circulation in the enclosure when the adsorption level is attained, (e) placing the enclosure under a vacuum, and (f) monitoring the radioactive activity of the radioactive gas adsorbed by the porous material at the end of step (c) by monitoring the scintillation of the porous material. The porous material comprises metal organic frameworks formed of inorganic sub-units constituted by Zn₄O and an organic ligand.

### TECHNICAL FIELD

The present invention relates to a method making it possible to check not only the storage of a radioactive gas within a porous material but also the measurement of the activity of the radioactive gas stored within that porous material.

In the context of the present invention, the radioactive gas is more particularly stored within the porous material by adsorption of that radioactive gas by the porous material.

The present invention also relates to an installation making it possible to check the storage and the radioactive activity of a radioactive gas, this radioactive gas being adsorbed by a porous material. This installation is more particularly configured for the implementation of the above-mentioned method of checking the storage and the radioactive activity.

The present invention further relates to a particular porous material as well as to its preparation method. This particular porous material is very suitable for the implementation of the method of checking the storage and the radioactive activity of the radioactive gas adsorbed by that material.

### PRIOR ART

Among the numerous porous materials in existence, those characterized by a high porosity and a high specific surface area are capable of adsorbing gases, or even storing them.

In the last twenty years, an emerging class of new porous materials with these porosity properties has come to light. These are the metal organic frameworks which are commonly designated by the terms “MOF” and “MOFs” corresponding to the acronym for “metal organic framework(s)”.

These porous materials are formed of inorganic sub-units bonded together by organic ligands via strong iono-covalent interactions, defining a crystallized structure. Composed of one or more metal cations, the inorganic sub-units play the role of cross-linking nodes. The number of coordination sites and their relative orientation define the geometry of the structure. For the choice of the organic ligands, it is possible to take advantage of all that organic chemistry has to offer, provided that the organic ligands have at least two complexing functions able to interact with the inorganic sub-units.

The organic-inorganic hybrid nature confers numerous properties on these porous materials which are modifiable and modular depending on the choice of the inorganic sub-units and of the organic ligands. One of the reasons for the rise of MOFs is their capacity to adsorb, store and even selectively adsorb any type of gas.

To check the radioactive activity of the radioactive gases adsorbed by MOFs, document US 7,985,868 B1 reports the synthesis of two porous materials of MOF type having scintillation properties by the presence of organic scintillator ligands. The first porous material is characterized by an advantageous specific surface area of the order of 500 m².g⁻¹ but by a low scintillation yield which is 9% relative to anthracene, which represents 1500 ph/MeV. The second porous material is characterized by a better scintillation yield, 22% here relative to anthracene, which represents approximately 3600 ph/MeV, but its specific surface area is not reported since it is probably poor.

However, in the case of spectroscopic tracing of radioactive gas, a scintillation yield of 1500 ph/MeV is a prohibitive value for the detection of certain types of gas, in particular those for which the radioactive emission is energetically low (less than 50 keV).

The object of the present invention is thus to mitigate the limitations of the porous materials described in document US 7,985,868 B1 and to provide a method which makes it possible to check the radioactive activity of the radioactive gases adsorbed into a porous material of MOF type or derivatives thereof, whatever the type of radioactive gases adsorbed by that porous material.

Another object of the invention is to propose that this method also makes it possible to check the storage of these same radioactive gases within these porous materials of MOF type or derivatives thereof.

### DISCLOSURE OF THE INVENTION

These objects as well as still others are achieved, firstly, by a method of checking the storage and the radioactive activity of a radioactive gas adsorbed by a porous material having scintillation properties.

The method of checking the storage and the radioactive activity according to the invention comprises the following steps:
(a) putting the porous material in place in an enclosure,
(b) performing circulation of the radioactive gas in the enclosure, whereby the radioactive gas is adsorbed by the porous material,
(c) monitoring the adsorption of the radioactive gas by the porous material by monitoring the scintillation of the porous material, up to an adsorption level, this adsorption level advantageously corresponding to the saturation of radioactive gas adsorbed by the porous material,
(d) interrupting the circulation of the radioactive gas in the enclosure when the adsorption level is attained,
(e) placing the enclosure under a vacuum, and
(f) monitoring the radioactive activity of the radioactive gas adsorbed by the porous material at the end of step (c) by monitoring the scintillation of the porous material,
the porous material comprising metal organic frameworks formed of inorganic sub-units bonded together by organic ligands, the inorganic sub-units being constituted by Zn₄O and the organic ligands being chosen from among terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis(para-benzoic)-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.

By “dicarboxylic derivative” of 2,5-diphenyloxazole, of 1,4-bis(5-phenyloxazol-2-yl) or of carbazole, is respectively meant all the positional isomers of the two acid functional groups of the dicarboxylic acid of 2,5-diphenyloxazole, of 1,4-bis(5-phenyloxazol-2-yl) or of carbazole.

Thus, by virtue of the implementation of the particular porous material of MOF type which has just been described, the method according to the invention makes it possible not only to monitor the adsorption by this porous material of the radioactive gases and, thereby, their storage within that porous material, but also to monitor the radioactive activity of these radioactive gases adsorbed and stored within this porous material by performing the in-line detection of the ionizing radiation originating from these radioactive gases. In particular, this monitoring of the adsorbed radioactive gases makes it possible to ensure that these radioactive gases remain properly trapped within the structure of the porous material. These monitoring of adsorption, storage and radioactive activity are provided by monitoring the scintillation of the porous material.

As indicated above, the porous material implemented in the method according to the invention comprises metal organic frameworks formed of inorganic sub-units bonded together by organic ligands, the inorganic sub-units being constituted by Zn₄O and the organic ligands being chosen from among:
terephthalic acid,
2,6-naphthalenedioic acid (or naphthalene-2,6-dicarboxylic acid),
1,6-biphenyldioic acid (or biphenyl-2,6-dicarboxylic acid),
9,10-anthracenedioic acid (or anthracene-9,10-dicarboxylic acid),
2,7-pyrenedioic acid (or pyrene-2,7-dicarboxylic acid),
1,8-terphenyldioic acid (or terphenyl-1,4-dicarboxylic acid),
9,10-di(para-benzoic)-anthracene (A),
2,5-bis-(para-benzoic)-1,3,4-oxadiazole (B),
a dicarboxylic derivative of 2,5-diphenyloxazole (C),
a dicarboxylic derivative of 1,4-bis(5-phenyloxazol-2-yl) (D), and
a dicarboxylic derivative of carbazole (E).

The porous material implemented in the method according to the invention is characterized by particular physicochemical and photophysical properties. This porous material has in particular the following properties:
a BET specific surface area comprised between 50 m²/g and 6000 m²/g and, advantageously, comprised between 500 m²/g and 6000 m²/g,
an emission wavelength λₑₘ comprised between 300 nm and 500 nm and, advantageously, comprised between 380 nm and 500 nm,
a fluorescence quantum yield ϕ such that ϕ ≥ 0.2 and, advantageously, such that ϕ ≥ 0.5,
a fluorescence decay τ comprised between 1 ns and 1 µs, and
a scintillation yield LY greater than or equal to 3000 ph/MeV and, advantageously, comprised between 4000 ph/MeV and 20000 ph/MeV.

In a variant of the method according to the invention, the porous material implemented in the method according to the invention is constituted by metal organic frameworks formed of inorganic sub-units bonded together by organic ligands, the inorganic sub-units being constituted by Zn₄O and the organic ligands being chosen from among terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.

When the organic ligands forming the metal organic frameworks of the porous material are constituted by terephthalic acid, the metal organic frameworks are advantageously MOFs known under the acronym IRMOF-1 or MOF-5.

When the organic ligands are constituted by 2,6-naphthalenedioic acid, the metal organic frameworks are advantageously MOFs known under the acronym IRMOF-8.

When the organic ligands are constituted by 1,6-biphenyldioic acid, the metal organic frameworks are advantageously chosen from among the MOFs known under the acronyms IRMOF-9 and IRMOF-10, these two MOFs being characterized by two different structures on account of the concatenation.

When the organic ligands are constituted by 2,7-pyrenedioic acid, the metal organic frameworks are advantageously MOFs known under the acronym IRMOF-14.

When the organic ligands are constituted by 1,8-terphenyldioic acid, the metal organic frameworks are advantageously MOFs known under the acronyms

IRMOF-15 and IRMOF-16, these two MOFs being characterized by two different structures on account of the concatenation.

When the organic ligands are constituted by 9,10-anthracenedioic acid, the metal organic frameworks are advantageously MOFs known under the acronym IRMOF-993.

When the organic ligands are constituted by 9,10-di(para-benzoic)-anthracene acid, the metal organic frameworks are advantageously MOFs known under the acronym IRMOF-A.

When the organic ligands are constituted by 2,5-bis-(para-benzoic)-1,3,4-oxadiazole acid, the metal organic frameworks are advantageously MOFs known under the acronym IRMOF-B.

When the organic ligands are constituted by a dicarboxylic derivative of 2,5-diphenyloxazole, the metal organic frameworks are advantageously MOFs known under the acronym IRMOF-C.

When the organic ligands are constituted by a dicarboxylic derivative of 1,4-bis(5-phenyloxazol-2-yl), the metal organic frameworks are advantageously MOFs known under the acronym IRMOF-D.

When the organic ligands are constituted by a dicarboxylic derivative of carbazole, the metal organic frameworks are advantageously MOFs known under the acronym IRMOF-E.

In an advantageous variant of the method according to the invention, the metal organic frameworks are chosen from among IRMOF-1, IRMOF-8, IRMOF-9,

IRMOF-10, IRMOF-14, IRMOF-15, IRMOF-16, IRMOF-993, IRMOF-A, IRMOF-B, IRMOF-C, IRMOF-D and IRMOF-E.

In another advantageous variant, the method according to the invention comprises, prior to step (a), a step (a0) consisting of placing the porous material in contact with a humid atmosphere.

This humid atmosphere may in particular be an atmosphere having a relative humidity comprised between 20% and 95% and, advantageously, comprised between 60% and 90%, this atmosphere being at a temperature comprised between 15° C. and 40° C. and, advantageously, comprised between 20° C. and 30° C.

In a variant, the porous material is placed in contact with the humid atmosphere for a duration comprised between 10 h and 48 h and, advantageously, comprised between 24 h and 36 h.

In an especially advantageous variant of the method according to the invention, the metal organic frameworks of the porous material are formed by the hydrated IRMOF-9.

In a variant, in step (b), the pressure of the radioactive gas in the enclosure is comprised between 700 hPa and 10000 hPa, advantageously comprised between 800 hPa and 2000 hPa and, preferably, comprised between 850 hPa and 1100 hPa.

In a variant, steps (b) and (c) are concomitant.

In a variant, in step (e), the pressure of the vacuum in the enclosure is comprised between 10⁻⁹ hPa and 1 hPa and, advantageously, comprised between 10⁻⁶ hPa and 10⁻² hPa.

In an especially advantageous variant of the method according to the invention, the monitoring of steps (c) and (f) are carried out by detection and counting of scintillation photons arising from the scintillation of the porous material by the triple-to-double coincidence ratio (TDCR) method.

This method, which requires the implementation of a scintillation counter comprising three photomultipliers, enables the average number of triple and double coincidences to be acquired. The detection yield is calculated from the ratio of these coincidences. By virtue of this method, each observed photon is assigned to an event and not to the proper movement of the detectors (background noise).

Secondly, the invention relates to an installation for checking the storage and the radioactive activity of a radioactive gas adsorbed by a porous material.

According to the invention, this installation comprises:
an enclosure configured to contain the porous material,
a circulation system for the radioactive gas configured to make the radioactive gas circulate in the enclosure,
a vacuum system configured for placing the enclosure under a vacuum,
a scintillation detection system configured for monitoring the adsorption of the radioactive gas by the porous material and for monitoring the radioactive activity of the radioactive gas adsorbed by the porous material, and
the porous material,
this porous material having scintillation properties and comprising metal organic frameworks formed of inorganic sub-units bonded together by organic ligands, the inorganic sub-units being constituted by Zn₄O and the organic ligands being chosen from among terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis(para-benzoic)-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.

This installation, which operates in a closed circuit and which in particular enables the circulation of radioactive gases as well as the counting of the photons, is more particularly configured for the implementation of the method of checking the storage and the radioactive activity described above. In other words, steps (a) to (f) of this method may be implemented within this installation according to the invention.

Thus, the installation according to the invention makes it possible to check by scintillation, by in-line and direct measurement, both the storage of the radioactive gases in the porous material and the radioactive activity of the gases so stored.

Preferably, the enclosure of the installation is light-proof to external light, in particular at the wavelengths comprised between 200 nm and 800 nm. In other words, the enclosure of the installation isolates its content from external light.

The scintillation detection system of the installation according to the invention may be chosen from among:
a metrological system comprising a TDCR detection device comprising three photomultipliers and enabling the implementation of the triple-to-double coincidence ratio (TDCR) method,
a system for α and/or β detection comprising two photomultipliers coupled to the enclosure,
a system for γ measurement, and
a system for β/γ or α/γ coincidence measurement comprising either a TDCR detection device comprising three photomultipliers and a γ detector, or a detection device with two photomultipliers and a γ detector.

Thirdly and fourthly, the invention relates to a method for preparing a hydrated porous material from a porous material comprising metal organic frameworks formed of inorganic sub-units constituted by Zn₄O and bonded together by organic ligands chosen from among dicarboxylic acids, as well as to the hydrated porous material per se.

According to the invention, the preparation method comprises:
(i) placing the porous material in contact with an atmosphere having a relative humidity comprised between 20% and 95% and being at a temperature comprised between 15° C. and 40° C., and
(ii) recovering the hydrated porous material,
the dicarboxylic acids being chosen from terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis(para-benzoic)-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.

In a variant, step (i) of placing in contact has a duration comprised between 10 h and 48 h.

The implementation of this method which comprises steps (i) and (ii) makes it possible to prepare a new porous material, here a hydrated porous material of which the spectroscopic properties, and in particular the scintillation emission wavelengths, are modified relative to those presented by the porous material from which it is obtained.

Thus, the hydrated porous material according to the invention which, as has just been indicated, can in particular be obtained by the preparation method described above, is characterized by the following properties:
a BET specific surface area comprised between 500 m²/g and 6000 m²/g,
an emission wavelength λₑₘ comprised between 380 nm and 500 nm,
a fluorescence quantum yield ϕ such that ϕ ≥ 0.5,
a fluorescence decay τ comprised between 1 ns and 1 µs, and
a scintillation yield LY comprised between 3000 ph/MeV and 20000 ph/MeV.

Other features and advantages of the invention will better appear on reading the additional description that follows and that relates to the synthesis of two porous materials (IRMOF-9 and H-MOF) one of which (H-MOF) constitutes the hydrated form of the other (IRMOF-9), to an installation making it possible to check the storage and the radioactive activity of a radioactive gas adsorbed by the hydrated porous material as well as to the characterization of the latter.

It is to be noted that these examples, which are in particular described in relation with the accompanying FIGS. 1 to 7, are only given by way of illustration of the subject-matters of the invention and in no case constitute a limitation of these subject-matters.

### BRIEF DESCRIPTION OF THE DRAWINGS

FIG. 1 is a diagrammatic representation of the installation used for the implementation of the method of checking the storage and the radioactive activity of a radioactive gas adsorbed by the hydrated porous material H-MOF in accordance with the invention.

FIG. 2a diagrammatic representation of the enclosure of the installation partially shown in FIG. 1, in which enclosure is placed the hydrated porous material H-MOF in accordance with the invention.

FIG. 2b is a diagrammatic representation of an enclosure that can be used in place of that shown in FIG. 2a.

FIG. 3 illustrates the normalized emission spectrum of the hydrated porous material H-MOF in accordance with the invention as a function of the emission wavelength (denoted λₑₘ and expressed in nm).

FIG. 4 illustrates the normalized fluorescence decay curve of the hydrated porous material H-MOF in accordance with the invention as a function of time (denoted τ and expressed in ns).

FIG. 5 illustrates the radio-luminescence spectra as a function of the wavelength (denoted λ and expressed in nm) of the hydrated porous material H-MOF in accordance with the invention, on the one hand, as well as the spectrum of a reference, on the other hand.

FIG. 6 expresses the evolution of the counting rate (denoted T_{compt} and expressed in s⁻¹) for the hydrated porous material H-MOF in the presence of radioactive gas as a function of the date of acquisition of the data (denoted D) as established between Jan. 10, 2020 (Oct. 01, 2020) and Jan. 22, 2020 (22/01/2020).

FIG. 7 expresses the evolution of the counting rate (denoted T_{compt} and expressed in s⁻¹) for the hydrated porous material H-MOF impregnated with radioactive gas as a function of the date of acquisition of the data (denoted D) as established between Jan. 21, 2020 (21/01/2020) and Jan. 22, 2020 (22/01/2020).

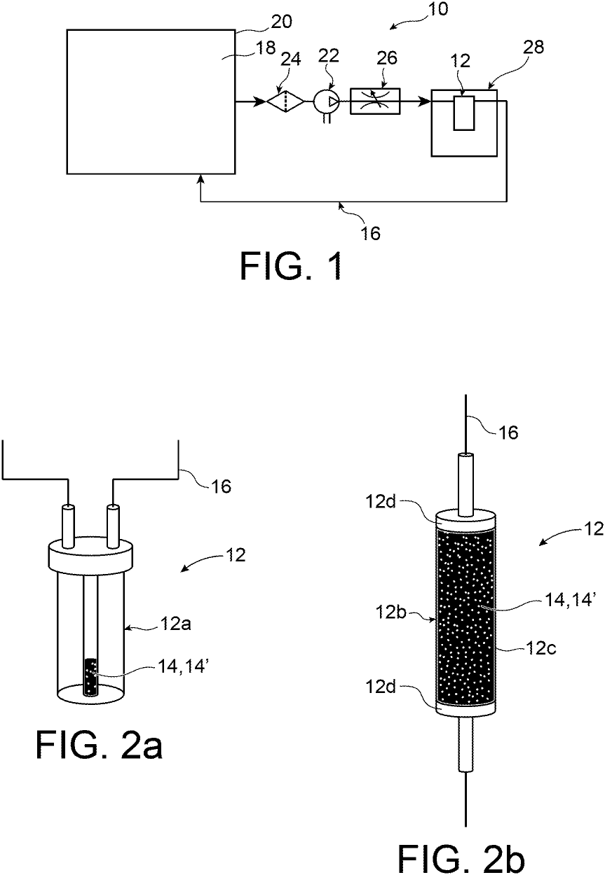

It is to be noted that that the elements in common between FIGS. 1, 2a and 2b are identified by the same numerical references.

### DETAILED DISCLOSURE OF PARTICULAR EMBODIMENTS

### 1. Synthesis of an IRMOF-9 Porous Material

As seen earlier, the porous material denoted IRMOF-9 comprises metal organic frameworks formed of inorganic sub-units constituted by Zn₄O and bonded together by organic ligands of 1,6-biphenyldioic acid.

This porous material IRMOF-9 is synthesized by dissolving 1.84 g (6.1 mmol) of zinc nitrate hexahydrate Zn(NO₃)₂·6H₂O with 500 mg (2 mmol) of 1,6-biphenyldioic acid (BPDC) in 50 mL of N,N-dimethylformamide (DMF). The solution is next introduced into pill boxes sealed and placed in an oven at 80° C. for 4 days. The recovered crystals are washed three times with anhydrous DMF then are stored in an inert atmosphere in a glove box in order to prevent any degradation that might occur.

### 2. Synthesis of a Hydrated Porous Material H-MOF in Accordance With The Invention

The hydrated porous material in accordance with the invention is prepared from the porous material IRMOF-9 synthesized according to the protocol described in paragraph 1 above.

The IRMOF-9 crystals are placed in a climate-controlled enclosure at 25° C. set at 80 % relative humidity for a duration of 24 h after which the hydrated crystals are removed from the enclosure.

The hydration product of the IRMOF-9, which corresponds to the hydrated porous material in accordance with the invention, is designated, in the rest of the present description, by the abbreviation H-MOF.

### 3. Installation

FIG. 1 diagrammatically represents an installation 10 in accordance with the invention, used for the implementation of the method of checking the storage and the radioactive activity of a gas adsorbed by the porous material having scintillation properties.

The installation 10 comprises an enclosure 12 configured to contain the porous material. This enclosure 12 may in particular be formed by a glass vial 12a as represented in FIG. 2a. The porous material 14 or, as the case may be, the hydrated porous material 14′ is placed in the center of the vial 12a.

The enclosure 12 may also be formed by a cartridge 12b as represented in FIG. 2b. This cartridge 12b comprises a transparent cylindrical body 12c within which is placed the porous material 14 or the hydrated porous material 14′. The cylindrical body 12c is provided at each of its ends with sintered glass 12d enabling the passage of the radioactive gas 18. Such an enclosure 12b enables the radioactive gas 18 to pass through the porous material 14, 14′ and, in doing so, to be independent of any diffusion dynamic.

The enclosure 12 is connected to a system 16 for circulation of the gas 18, which here is radioactive gas 18, configured to pass the radioactive gas 18 from a reservoir 20 into the enclosure 12. This circulation system 16 comprises in particular a pump 22, a flowmeter 26 and a filter 24. This filter 24 is typically what is referred to as a “very high efficiency” or “VHE” filter, which is able to eliminate, if there is any, dust in the form of aerosol in the atmosphere charged with radioactive gas 18.

As there are constraints in the implementation of gas 18, which may in particular have a radioactive activity comprised between 10 mBq.m⁻³ and 200 MBq.m⁻³, this circulation system 16 must be verified reliably, operating in particular in a closed circuit and under controlled pressure.

The installation 10 according to the invention further comprises a system for placing under a vacuum (not shown in FIG. 1) which is configured to place under a vacuum the enclosure 12, as well as a scintillation detection system 28.

This scintillation detection system 28 is configured for monitoring the adsorption of the radioactive gas 18 by the porous material 14, 14′ and for monitoring the radioactive activity of the radioactive gas 18 adsorbed by the porous material 14, 14′. This detection system 28, which enables the direct measurement of the photons arising from the scintillation process, may also constitute a manner of external detection enabling the detection of the γ radiation emitted by certain isotopes of the radioactive gas 18.

### 4. Characterization of the Hydrated Porous Material H-MOF

### 4.1 The Hydrated Porous Material H-MOF According to the Invention Was First of All Studied by Photoluminescence By Means of a Spectrofluorimeter

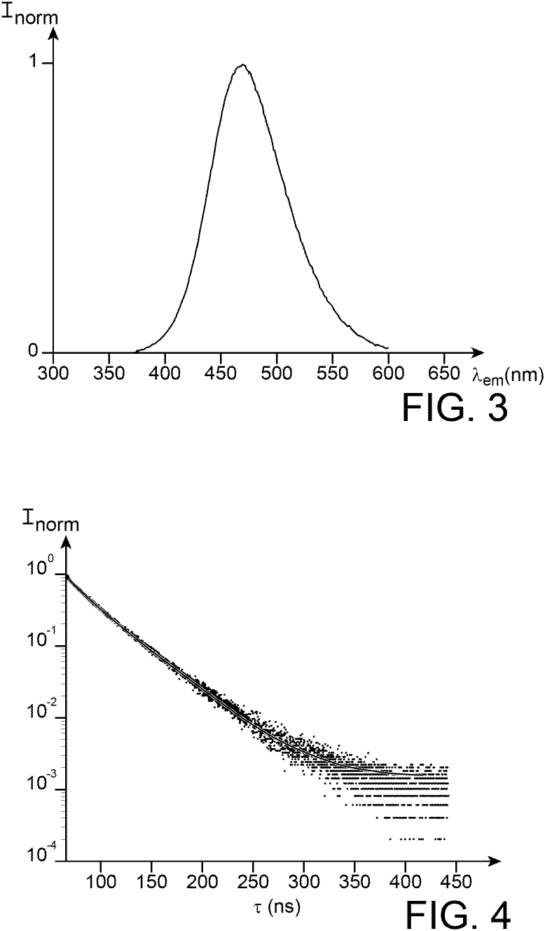

The normalized emission spectrum obtained for H-MOF, which expresses the evolution of the normalized intensity denoted Iₙₒᵣₘ as a function of the emission wavelength λₑₘ after an excitation at an excitation wavelength of 360 nm, is shown in FIG. 3. It is noted that the profile of this emission spectrum is close to a Gaussian curve centered on an emission wavelength λmaxₑₘ of 460 nm. The measurement of the fluorescence quantum yield ϕ achieved gives a value of ϕ of the order of 0.75.

By way of comparison, these same values measured for IRMOF-9 respectively give an emission wavelength λmaxₑₘ of 350 nm and a fluorescence quantum yield ϕ of 0.2.

FIG. 4 shows the normalized fluorescence decay curve, or fluorescence lifetime curve, of the emission observed at 460 nm. This curve, which expresses the evolution of the normalized intensity denoted Iₙₒᵣₘ as a function of time τ in ns, is adjusted using a mono-exponential curve and makes it possible to get close to a value of fluorescence lifetime τ of 40 ns.

The study by photoluminescence thus makes it possible to note a shift in the emission wavelength λₑₘ, an increase in the fluorescence quantum yield ϕ and an extension in the fluorescence lifetime τ of the hydrated porous material H-MOF according to the invention relative to IRMOF-9.

### 4.2 To Evaluate The Effectiveness of The Hydrated Porous Material H-Mof in Accordance With The Invention As A Scintillator, A Radio-Luminescence Experiment Was Next Performed

A sample of hydrated porous material H-MOF was placed opposite a photomultiplier equipped with an adjustable monochromator while a solid radioactive source was disposed behind the sample for excitation purposes. Photons are then collected.

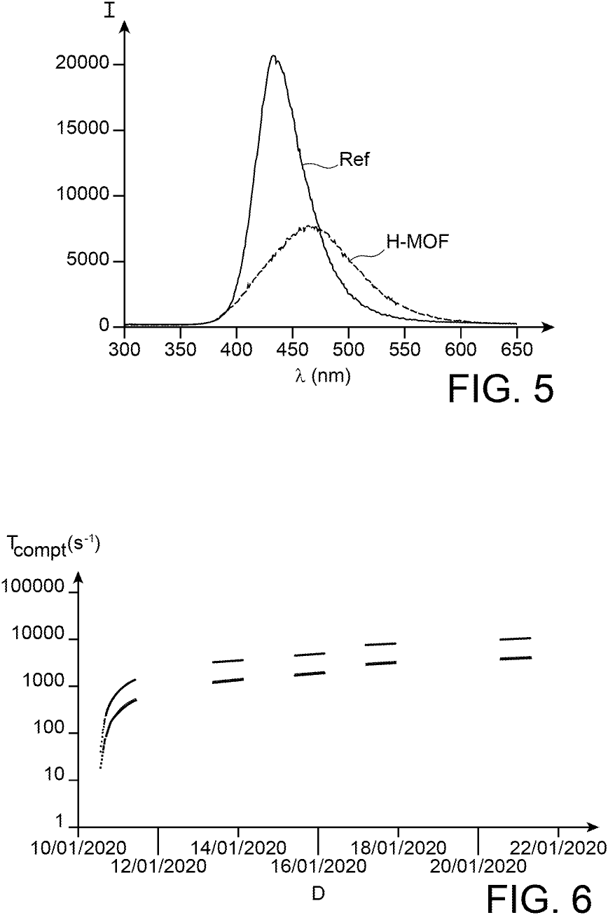

The radio-luminescence spectrum obtained for the hydrated porous material H-MOF is illustrated in FIG. 5 by the curve denoted H-MOF.

By calculating the area under this H-MOF curve and by comparing it with the area calculated under the reference curve measured at 7000 ph/MeV and denoted Ref in that same FIG. 5, it is possible to deduce a scintillation yield LY of the order of 4500 ph/MeV.

The values of the photo-physical properties characterizing the hydrated porous material H-MOF in accordance with the invention are given in Table 1 below.

TABLE 1

| Properties | Invention | H-MOF | IRMOF-9 |
|---|---|---|---|
| Emission wavelength λₑₘ (nm) | 300 - 500 | 460 | 350 |
| Fluorescence quantum yield ϕ | ≥ 0.2 | 0.75 | 0.2 |
| Fluorescence decay τ (ns) | 1-1000 | 40 | 3.7 (92%) 16 (8%) |
| Scintillation yield LY (ph/MeV) | ≥ 3000 | 4500 | (not measured) |

It is thus observed that the hydration of the IRMOF-9 makes it possible to obtain a new porous material, H-MOF, which is characterized by new properties, in particular by photo-physical properties which are particularly advantageous which will be taken advantage of in the gas adsorption and retention tests, on the one hand, and in the scintillation and radioactive activity measurement tests, on the other hand, which are reported upon below.

### 5. Performance of the H-MOF Material

To evaluate the performance in terms of storage and of radioactive activity of the hydrated porous material H-MOF, the hydrated porous material H-MOF in accordance with the invention was incorporated in the vial 12a of the installation 10 equipped with a metrology system comprising an TDCR detection device provided with three photomultipliers making it possible to acquire the average number of triple and double coincidences by the triple-to-double coincidence ratio method (TDCR method) as a scintillation detection system 28.

This detection system 28 makes it possible to acquire the average number of triple and double coincidences, enabling the calculation of the detection yield from the ratio of these coincidences. It may be used in a dynamic or stationary mode.

In the dynamic mode, the monitoring by counting rate is made in the presence of radioactive gas. The hydrated porous material H-MOF adsorbs the gas. The ionizing radiation then excites said material and enables the production of photons (dependent on the radioactive source and on its activity within the material). It is then possible to monitor the incorporation of radioactive gas in the material by scintillation. The detection system 28 then serves as a detector.

In the stationary mode, the hydrated porous material H-MOF is already impregnated with radioactive gas and retains it within itself. The hydrated porous material H-MOF is then placed opposite the photomultipliers to estimate a counting rate making it possible to trace an activity. It is then possible to employ the hydrated porous material H-MOF as a storage entity capable of giving an estimate of the activity as a function of the counting rate by scintillation (x counts per second equivalent to y Bq). The detection system 28 then serves as a gauge.

### 5.1 Test of Gas Adsorption and Retention (Storage)

The ionizing gas is first of all circulated in the absence of porous material in the vial 12a to perform the acquisition of the proper movement of the detection system 28 (also called background noise)

150 mg of hydrated porous material H-MOF are then introduced into the vial 12a but in the absence of ionizing gas to acquire a second blank.

These two acquisitions show a negligible counting rate. The first is zero while the second is 0.5 s⁻¹. This very slight increase is primarily due to the interaction of external radiation passing through the measuring device and depositing a little energy in the H-MOF.

In the circulation system 16 there is then circulated ⁸⁵Kr radioactive gas of 10 kBq activity at a pressure of 890 hPa and at a temperature of 20° C., which represents a volume activity of approximately 50 Bq.cm⁻³.

As illustrated in FIG. 6, the acquisition reveals a clear increase of the counting rate over time with saturation being reached for a counting rate of 10000 counts/s.

This tendency reveals an adsorption and a concentration of the radioactive gas within the hydrated porous material H-MOF. This is the experimental evidence of dynamic detection by scintillation.

### 5.2 Test of Radioactive Activity

The circulation of the ⁸⁵Kr radioactive gas of 10 kBq activity is next cut off and a medium vacuum of 10⁻³ hPa is applied in the vial 12a.

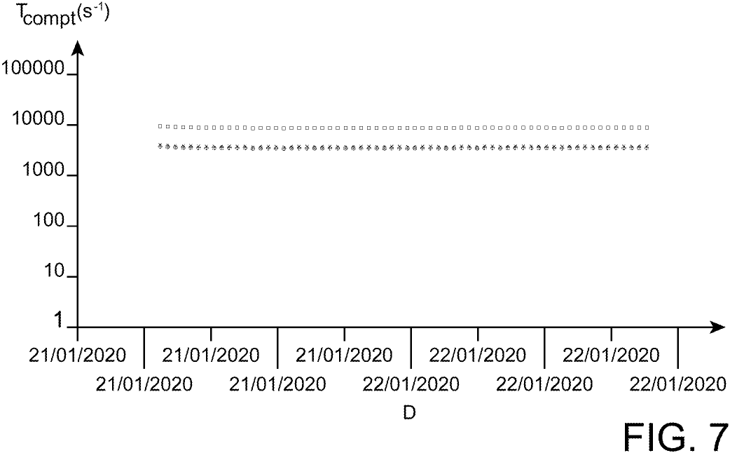

As illustrated in FIG. 7, the curve illustrating the counting rate does not make it possible to highlight a clear inflection.

This is the experimental evidence of the retention, and thus of the storage, of the ⁸⁵Kr radioactive gas within the hydrated porous material H-MOF according to the invention, under a medium vacuum and of its monitoring by direct measurement. In other words, it is possible to evaluate the quantity of radioactive gas in the hydrated porous material H-MOF accurately and, thereby, the radioactive activity of said material.

In view of the above, the hydrated porous material in accordance with the invention, such as the H-MOF material which has just been studied, is a material that possesses properties of adsorption, storage and fluorescence and which, placed in an installation equipped with a detection system capable of counting photons, makes it possible to determine accurately the quantity of adsorbed radioactive gas and to check its stability over time.

The method of checking the storage and the radioactive activity of a radioactive gas according to the invention, the installation according to the invention as well as the hydrated porous material according to the invention may in particular find application in one of the following fields:
for the monitoring of activity of emissions of ³H and ⁸⁵Kr from nuclear power stations and radioactive waste processing plants;
for the storage of radioactive gases with active monitoring of the level and of their confinement;
in the field of radiation protection, for example for measuring the volume activity of radon in the air;
in the field of underground nuclear explosion detection, by measuring the volume activity of the isotopes of xenon or of ³⁷Ar; and/or
in the field of the monitoring of seismic activity and of emission of greenhouse gases, by measuring the volume activity of radon in the air.

### BIBLIOGRAPHY

US 7,985,868 B1

What is claimed is:

1. A preparation method for preparing a hydrated porous material from a porous material comprising metal organic frameworks formed of inorganic sub-units constituted by Zn₄O and bonded together by organic ligands chosen from among dicarboxylic acids, which method comprises:
(i) placing the porous material in contact with an atmosphere having a relative humidity comprised between 20% and 95% and being at a temperature comprised between 15° C. and 40° C., and
(ii) recovering the hydrated porous material,
the dicarboxylic acids being chosen from terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis(para-benzoic)-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.

2. The preparation method according to claim 1, wherein step (i) of placing in contact has a duration comprised between 10 h and 48 h.

3. A hydrated porous material obtained by the preparation method according to claim 1, the hydrated porous material having the following properties:
a BET specific surface area comprised between 500 m²/g and 6000 m²/g,
an emission wavelength λₑₘ comprised between 380 nm and 500 nm,
a fluorescence quantum yield φ such that φ ≥ 0.5,
a fluorescence decay τ comprised between 1 ns and 1 µs, and
a scintillation yield LY comprised between 3000 ph/MeV and 20000 ph/MeV.

4. A method of checking the storage and the radioactive activity of a radioactive gas adsorbed by a porous material having scintillation properties, this method comprising the following steps:
(a) putting the porous material in place in an enclosure,
(b) performing circulation of the radioactive gas in the enclosure, whereby the radioactive gas is adsorbed by the porous material,
(c) monitoring the adsorption of the radioactive gas by the porous material by monitoring the scintillation of the porous material, up to an adsorption level, this adsorption level advantageously corresponding to the saturation of radioactive gas adsorbed by the porous material,
(d) interrupting the circulation of the radioactive gas in the enclosure when the adsorption level is attained,
(e) placing the enclosure under a vacuum, and
(f) monitoring the radioactive activity of the radioactive gas adsorbed by the porous material at the end of step (c) by monitoring the scintillation of the porous material (c),
wherein the porous material comprises metal organic frameworks formed of inorganic sub-units bonded together by organic ligands, the inorganic sub-units being constituted by Zn₄O and the organic ligands being chosen from among terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis(para-benzoic)-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.

5. The method of checking the storage and the radioactive activity according to claim 4, wherein the porous material is constituted by metal organic frameworks formed of inorganic sub-units bonded together by organic ligands, the inorganic sub-units being constituted by Zn₄O and the organic ligands being chosen from among terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis(para-benzoic)-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.

6. The method of checking the storage and the radioactive activity according to claim 4, wherein the porous material has the following properties:
a BET specific surface area comprised between 50 m²/g and 6000 m²/g and, advantageously, comprised between 500 m²/g and 6000 m²/g,
an emission wavelength λₑₘ comprised between 300 nm and 500 nm and, advantageously, comprised between 380 nm and 500 nm,
a fluorescence quantum yield φ such that φ ≥ 0.2 and, advantageously, such that φ ≥ 0.5,
a fluorescence decay τ comprised between 1 ns and 1 µs, and
a scintillation yield LY greater than or equal to 3000 ph/MeV and, advantageously, comprised between 3000 ph/MeV and 20000 ph/MeV.

7. The method of checking the storage and the radioactive activity according to claim 4, wherein the metal organic frameworks are chosen from among IRMOF-1, IRMOF-8, IRMOF-9, IRMOF-10, IRMOF-14, IRMOF-15, IRMOF-16, IRMOF-993, IRMOF-A, IRMOF-B, IRMOF-C, IRMOF-D and IRMOF-E.

8. The method of checking the storage and the radioactive activity according to claim 4, which comprises, prior to step (a), a step (a0) consisting of placing the porous material, in contact with a humid atmosphere.

9. The method of checking the storage and the radioactive activity according to claim 8, wherein the humid atmosphere is an atmosphere having a relative humidity comprised between 20% and 95% and being at a temperature comprised between 15° C. and 40° C.

10. The method of checking the storage and the radioactive activity according to claim 8, wherein the porous material is placed in contact with the humid atmosphere for a duration comprised between 10 h and 48 h.

11. The method of checking the storage and the radioactive activity according to claim 8, wherein the metal organic frameworks are formed by hydrated IRMOF-9.

12. Method of checking the storage and the radioactive activity according to claim 4, wherein, in step (b), the pressure of the radioactive gas in the enclosure is comprised between 700 hPa and 10000 hPa and, advantageously, comprised between 800 hPa and 2000 hPa.

13. The method of checking the storage and the radioactive activity according to claim 4, wherein, in step (e), the pressure of the vacuum in the enclosure is comprised between 10⁻⁹ hPa and 1 hPa.

14. The method of checking the storage and the radioactive activity according to claim 4, wherein steps (b) and (c) are concomitant.

15. The method of checking the storage and the radioactive activity according to claim 4, wherein the monitoring of steps (c) and (f) are carried out by detection and counting of scintillation photons arising from the scintillation of the porous material by the triple-to-double coincidence ratio (TDCR) method.

16. An installation for checking the storage and the radioactive activity of a radioactive gas adsorbed by a porous material comprising:
an enclosure configured to contain the porous material
a circulation system for the radioactive gas configured to make the radioactive gas circulate in the enclosure,
a vacuum system configured for placing the enclosure under a vacuum,
a scintillation detection system configured for monitoring the adsorption of the radioactive gas by the porous material and for monitoring the radioactive activity of the radioactive gas adsorbed by the porous material, and
the porous material,
wherein the porous material has scintillation properties and comprises metal organic frameworks formed of inorganic sub-units bonded together by organic ligands, the inorganic sub-units being constituted by Zn₄O and the organic ligands being chosen from among terephthalic acid, 2,6-naphthalenedioic acid, 1,6-biphenyldioic acid, 1,8-terphenyldioic acid, 9,10-anthracenedioic acid, 2,7-pyrenedioic acid, 9,10-di(para-benzoic)-anthracene acid, 2,5-bis(para-benzoic)-1,3,4-oxadiazole acid, a dicarboxylic derivative of 2,5-diphenyloxazole, a dicarboxylic derivative of 1,4-bis(5-phenyloxazol-2-yl) and a dicarboxylic derivative of carbazole.
